(19) United States
(12) Patent Application Publication
(10) Pub. No.: US 2005/0161085 A1
(43) Pub. Date: Jul. 28, 2005

(54) Vent valve for re-circulating hydraulic system

(76) Inventors: Gregory A. Haunhorst, Maumee, OH (US); Mark A. Clark, Rochester, MI (US); John M. Dooley, Chesterfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/856,671

(22) Filed: May 28, 2004

Related U.S. Application Data
(60) Provisional application No. 60/520,744, filed on Nov. 17, 2003.

(51) Int. Cl. F16K 24/04

(52) U.S. Cl. 137/202

(57) ABSTRACT

A secondary reservoir for a power steering system includes a container having an inside volume configured to hold a fluid, a cover attached to the container, a float assuming a height within the container indicative of a level of the fluid within the container, and a vent valve configured to open the inside volume of the container to an outside atmosphere when the float is at a relatively low level within the container and to close the inside volume of the container when the float is above the low level.

### RELATED APPLICATIONS

The present application claims priority under 35 U.S.C. § 119(e) from the following previously-filed Provisional Patent Application, U.S. application Ser. No. 60/520,744, filed Nov. 17, 2003 by Haunhorst et al., entitled “Vent Valve for Power Steering System” which is incorporated herein by reference in its entirety.

### FIELD

The present systems and methods relate to pressurized hydraulic systems. More particularly, the present systems and methods relate to a secondary reservoir for a pressurized hydraulic system, which uses a variable volume hose as a primary reservoir.

### BACKGROUND

Traditional re-circulating hydraulic systems such as power steering systems for motor vehicles include a fluid reservoir that provides fluid via a lower pressure supply hose to a pump. The pump pressurizes the fluid and then feeds the fluid to an actuator, such as a steering rack, through a high pressure hose assembly. The displaced fluid then returns to the reservoir via the low pressure return line.

The reservoir portion of a re-circulating hydraulic system performs a variety of functions. The reservoir provides a serviceable means of charging the system with fresh fluid while also holding excess fluid created from thermal changes within the system. Additionally, many reservoirs provide a means of allowing for the escape of any air separated out of the fluid whilst resident in the reservoir.

However, the use of a reservoir is undesirable in certain circumstances. For example, a reservoir occupies a relatively large amount of space and also necessitates the use of a relatively large amount of fluid. Consequently, reservoirs often consume valuable space in locations where space is at a premium such as automobile engine compartments. Additionally, traditional reservoirs cannot normally be hermetically sealed.

Recently, expandable hydraulic hoses have been used in conjunction with re-circulating hydraulic systems to provide a variable volume primary reservoir. For example, U.S. Pat. No. 5,727,390, the disclosure of which is hereby incorporated by reference, illustrates a vehicle power steering system that uses an expandable hose in the low pressure side of the system for use as a variable volume reservoir for the hydraulic fluid. As the fluid is heated by the pump, its volume increases, which is ideally accommodated by the variable volume primary reservoir.

While variable volume primary reservoirs greatly reduce the amount of space sought to include a reservoir, traditional systems incorporating variable volume primary reservoirs suffer from a number of deficiencies. For example, because the volume of the variable volume primary reservoirs is controlled in a reactive manner based on the pressure of the hydraulic fluid present in the system, the primary reservoirs only properly operate under a range of pressure conditions. Additionally, sealing a variable volume primary reservoir to allow the buildup of pressure therein makes the reservoir susceptible to over pressure conditions that may result in a rupture or other failure of the structural integrity of the variable volume primary reservoir. Moreover, permanently sealing the variable volume primary reservoir may facilitate the build up of inappropriate pressures in the hydraulic system. Additionally, permanently sealing the variable volume primary reservoir may create a vacuum that may cause cavitation on the impellers of the pump or cause other damage to the components of the hydraulic system.

### SUMMARY

A secondary reservoir for a power steering system includes a container having an inside volume configured to hold a fluid, a cover attached to the container, a float assuming a height within the container indicative of a level of the fluid within the container, and a vent valve configured to open the inside volume of the container to an outside atmosphere when the float is at a relatively low level within the container and to close the inside volume of the container when the float is above the low level.

A method for accommodating thermal fluid expansion in a hydraulic system includes coupling the secondary reservoir to a variable volume primary reservoir, and selectively hermetically sealing the secondary reservoir, containing hydraulic fluid, in response to a level of the hydraulic fluid within the secondary reservoir.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a simple block diagram illustrating a simple re-circulating hydraulic system.

FIG. 2 is a partial cross-sectional view of a secondary reservoir utilizing a float and a ball valve in a vent valve, according to a first exemplary embodiment.

FIG. 3 is a cross-sectional view of an exemplary float and inverted umbrella type valve assembly that may be used for a vent valve.

FIG. 4 is a magnified cross-sectional view of an exemplary inverted umbrella type valve assembly seated against a seal plate.

FIG. 5 is a front perspective view of an exemplary inverted umbrella seal.

FIG. 6 is a rear perspective view of an exemplary inverted umbrella seal.

FIG. 7 is a cross-sectional view of a secondary reservoir utilizing a float and poppet type vent valve, according to a second exemplary embodiment.

FIG. 8 is a cross-sectional view of a secondary reservoir including a cover having an o-ring seal mounted at a varying angle relative to the vertical axis of the secondary reservoir, thereby providing for the uncovering of a vent (bleed) hole prior to complete disengagement of the cover, according to a third exemplary embodiment.

FIG. 9 is a cross-sectional view of a secondary reservoir utilizing a floating ball in the vent valve without a separate float element, according to a fourth exemplary embodiment.

FIG. 10 is a cross-sectional view of a secondary reservoir utilizing a needle in the vent valve that is attached to a float, according to a fifth exemplary embodiment

Throughout the drawings, identical reference numbers designate similar, but not necessarily identical, elements.

### DETAILED DESCRIPTION

A number of exemplary systems and methods for providing a vent valve for a re-circulating hydraulic system are described herein. More specifically, the present exemplary systems and methods provide for controlling the expansion of a variable volume primary reservoir based on the thermally activated expansion of the hydraulic fluid in the system. By regulating access to the atmosphere based on a floating valve interface, the present secondary reservoir system and method reliably increase pressure in the hydraulic system when an increased volume of fluid is present. Additionally, the present systems and methods provide a reliable method for releasing excess air or gas from the hydraulic system while providing for the relief of overpressure conditions and removal of residual pressure. A number of exemplary components and configurations of the present systems and methods are illustrated below.

In the following description, for purposes of explanation, numerous specific details are set forth to provide a thorough understanding of the present systems and methods for providing a vent valve for a re-circulating hydraulic system. It will be apparent, however, to one skilled in the art, that the present systems and processes may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

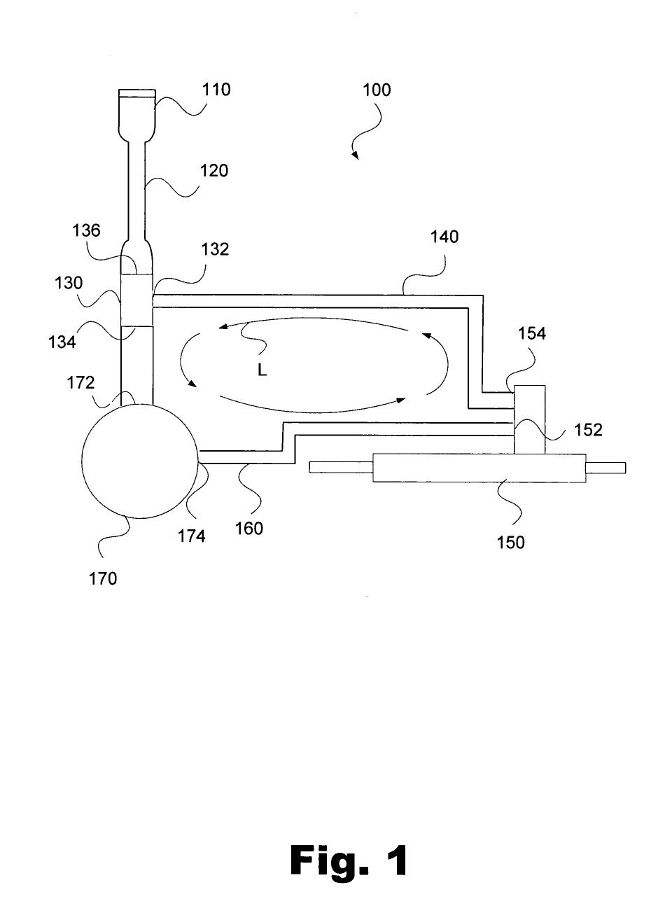

FIG. 1 illustrates a re-circulating hydraulic system (100) according to one exemplary embodiment. The re-circulating hydraulic system (100) may be used in any number of hydraulic systems including, but in no way limited to, a hydraulic power steering system. As illustrated in FIG. 1, the exemplary re-circulating hydraulic system (100) includes a hydraulic pump (170) fluidly coupled to an actuator (150) by a high pressure feed line (160) and a low pressure return line (140). The low pressure return line (140) provides direct fluid communication between an outlet (154) from the actuator (150) and an inlet (172) of the pump (170). Similarly, the high pressure feed line (160) provides direct fluid communication between an outlet (174) of the pump (170) and an inlet (152) of the actuator (150). Accordingly, the pump (170), the actuator (150), and the feed and return lines (160, 140) respectively define a re-circulating path or loop L (shown diagrammatically in FIG. 1). Additionally, an air separator (130) is associated with the low pressure return line (140) and acts to remove air from the hydraulic fluid as it is re-circulated around the loop L by the pump (170). Moreover, as shown in FIG. 1, a variable volume primary reservoir (120) and a secondary reservoir (110) are fluidly coupled to the system (100). Further explanation of the structure and the function of the independent elements forming the exemplary re-circulating hydraulic system (100) of FIG. 1 will be given below.

The pump (170) illustrated in FIG. 1 is configured to selectively provide hydraulic pressure to the actuator (150). Accordingly, the pump (170) may include, but is in no way limited to, a rotary vane pump or any other hydraulic fluid pumping apparatus. As the pump (170) varies the hydraulic pressure in the high pressure feed line (160), pressure is applied to the actuator (150). The actuator (150) receives force assist pressure from the pump (170). Consequently, the actuator (150) may be any number of hydraulically assisted actuators including, but in no way limited to, a steering rack or a recirculating-ball steering system.

The air separator (130), illustrated in FIG. 1 is configured to remove unwanted air that is present in the hydraulic fluid of the hydraulic system (100). As illustrated in FIG. 1, the air separator (130) includes a fluid inlet port (132), through which fluid enters from the low pressure return line (140). Additionally, there is an outlet port (134) located at the bottom axial end of the air separator (130), through which fluid exits along a downstream portion to the pump (170). According to one exemplary embodiment, the air separator (130) includes a fluid communication port (136) located at the upper axial end of the air separator (130) and a flow diversion means (not shown) configured to encourage the separation of air out of the hydraulic fluid.

Separation of air out of the hydraulic fluid is encouraged by varying the pressure, velocity, and volume of various flow paths within the air separator (130), thereby encouraging air dissolved in the fluid to separate out and flow through the variable volume primary reservoir (120) into the secondary reservoir (110). While only one type of air separator is described above, various types of prior art gas-liquid (air) separators can be used with the present system and method to assist in separating ingested air out of the hydraulic fluid. Examples of appropriate air separators can be seen in U.S. Pat. Nos. 1,734,507; 2,578,568; 2,590,754; 3,267,188; 3,812,655; 3,912,468; and 3,996,027, the disclosures of which are hereby incorporated by reference.

As illustrated in FIG. 1, the air separator (130) is coupled to a variable volume primary reservoir (120). The variable volume primary reservoir (120), which is fluidly coupled to the hydraulic system (100), is constructed so as to vary its internal volume in response to volume and/or pressure changes in the hydraulic fluid contained within the system. Variations in volume and/or pressure can be caused by, for example, thermal expansion/contraction. The variable volume primary reservoir (120) therefore functions as a volume buffer for hydraulic fluid contained within the system, while arranging to temporarily provide a source of excess fluid for supply to the re-circulating loop L, thereby preventing cavitation of the pump. According to one exemplary embodiment, the variable volume primary reservoir (120) may be a flexible walled tube or an expandable hose configured to expand in response to changing volumes and pressures of the hydraulic fluid contained within the system.

The secondary reservoir (110) that is fluidly coupled to the variable volume primary reservoir (120) performs a number of functions within the exemplary hydraulic system (100). According to one exemplary embodiment, the secondary reservoir (110) provides a serviceable means of charging the hydraulic system (100) with fresh fluid. Additionally, the secondary reservoir (110) accommodates excess hydraulic fluid created from thermal expansion of the hydraulic fluid and provides a means of allowing any air to separate out of the hydraulic fluid whilst resident in the reservoir. However, an inability to control the internal pressure of traditional secondary reservoirs often nullifies much of the expandable nature of the variable volume primary reservoir (120). That is, variable volume primary reservoirs (120) expand in response to an increased pressure within the hydraulic system (100), often caused by an increased volume of hydraulic fluid therein. However, an inability to control the internal pressure of traditional secondary reservoirs leaves the expansion and contraction of the variable volume primary reservoir (120) subject to pressure changes resulting from expansion and contraction of hydraulic fluid. Additionally, traditional secondary reservoirs known to the inventors cannot be both hermetically sealed and provide for release of air and other gasses removed from the hydraulic fluid. Rather, traditional secondary reservoirs are designed either to remove excess air or be hermetically sealed.

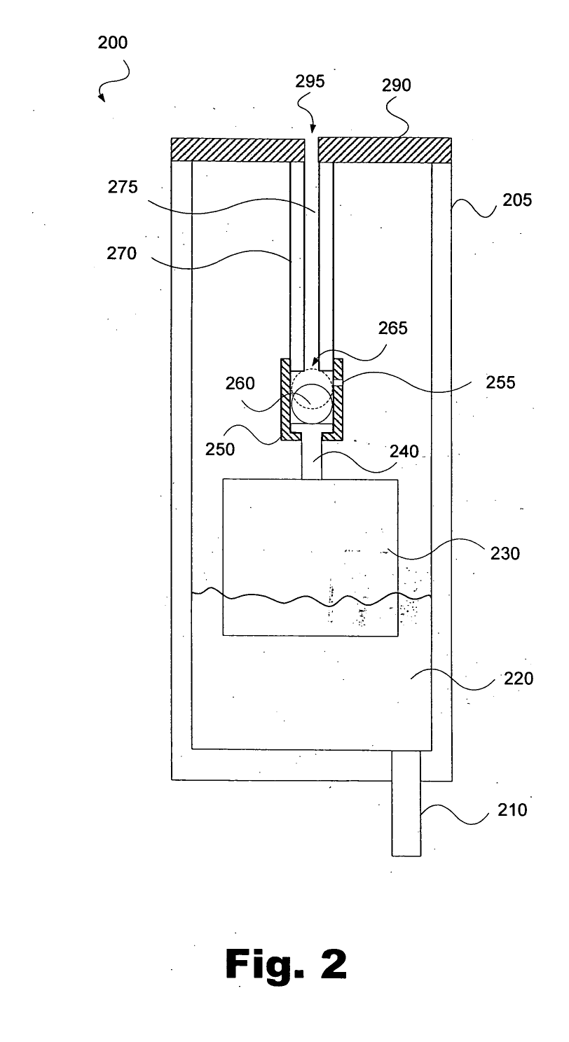

In contrast to traditional secondary reservoirs, FIG. 2 illustrates an exemplary secondary reservoir (200) configured to provide the traditional functions listed above: that of providing a serviceable means of charging the hydraulic system (100; FIG. 1) with fresh fluid while accommodating excess hydraulic fluid created in the system from thermal changes. Additionally, the exemplary secondary reservoir (200) allows for pressure manipulation and improved operation of the variable volume primary reservoir (120; FIG. 1) by selectively providing a hermetic seal or a release of excess air and gas, as will be explained in further detail below.

As shown in FIG. 2, the exemplary secondary reservoir (200) includes a body or fill cup (205) configured to accommodate excess hydraulic fluid (220) from the hydraulic system (100; FIG. 1). The fill cup (200) is fluidly coupled to the variable volume primary reservoir (120; FIG. 1) of a hydraulic system (100; FIG. 1) by a fluid coupler (210) that extends into the fill cup. The fluid coupler (210) facilitates the transfer of excess hydraulic fluid (220) and air from the hydraulic system (100; FIG. 1) to the secondary reservoir (200). Additionally, according to one exemplary embodiment, the fill cup (205) is selectively hermetically sealed by a cover (290) and a vent tube (270) having a vent valve (250) coupled thereto. As illustrated in the first exemplary embodiment shown in FIG. 2, the cover (290) includes a cover orifice (295) concentric with the vent passage (275) of the vent tube (270). Consequently, the vent tube (270) is coupled to the external atmosphere.

Additionally, as illustrated in FIG. 2, the vent valve (250) includes a number of components configured to selectively seal the interior of the fill cup (205) from the vent passage (275), and consequently, the atmosphere. As shown, the vent valve (250) includes a ball valve (260) or another three-dimensional object disposed on a sliding contact pin (240) that, in turn, is coupled to a buoyant float (230). As the position of the buoyant float (230) changes with the level of the hydraulic fluid (220), the change in position is translated through the sliding contact pin (240) to the ball valve (260).

An air orifice (255) is also disposed in at least one side of the vent valve (250) to provide fluid communication between the inner portion of the fill cup (205) and the vent passage (275) when the ball valve (260) is in a recessed position. When the ball valve (260) is in the recessed position, an open passage is present from the fill cup (205), to the atmosphere, providing a vent for the escape of pressure and/or air or other gasses that have been removed from the hydraulic fluid (220) in the air separator (130; FIG. 1) or otherwise. Consequently, when the ball valve (260) is in the recessed position, the pressure inside the fill cup (205) is substantially the same as the external atmosphere.

However, as illustrated in FIG. 2, when actuated the ball valve (260) is configured to abut the seal diameter (265) of the vent passage (275), thereby eliminating the fluid communication between the inner portion of the fill cup (205) and the vent passage (275). By selectively eliminating the fluid communication between the inner portion of the fill cup (205) and the vent passage (275), the present exemplary system illustrated in FIG. 2 provides for the improved operation of a hydraulic system (100; FIG. 1) that makes use of a variable volume primary reservoir (120). According to the first exemplary system illustrated in FIG. 2, the secondary reservoir (200) has a relatively small capacity such that is at certain times the secondary reservoir is vented to atmosphere and at other times is sealed off from the atmosphere, depending on the level of the hydraulic fluid contained therein. The selective sealing of the secondary reservoir can be used to control the system pressures that, in turn, control the expansion of the variable volume primary reservoir (120).

Specifically, in the secondary reservoir illustrated in FIG. 2, the float (230) within the fill cup (205) of the secondary reservoir (200) buoyantly follows the level of the hydraulic fluid (220) disposed therein due to the buoyancy of the float. As shown in FIG. 2, the float (230) is coupled to a sliding contact pin (240) that is, in turn, coupled to the ball valve (260). When the hydraulic fluid (220) is relatively cold and the float level is low, the ball valve (260) is in a recessed position allowing air to enter the hydraulic system (100; FIG. 1).

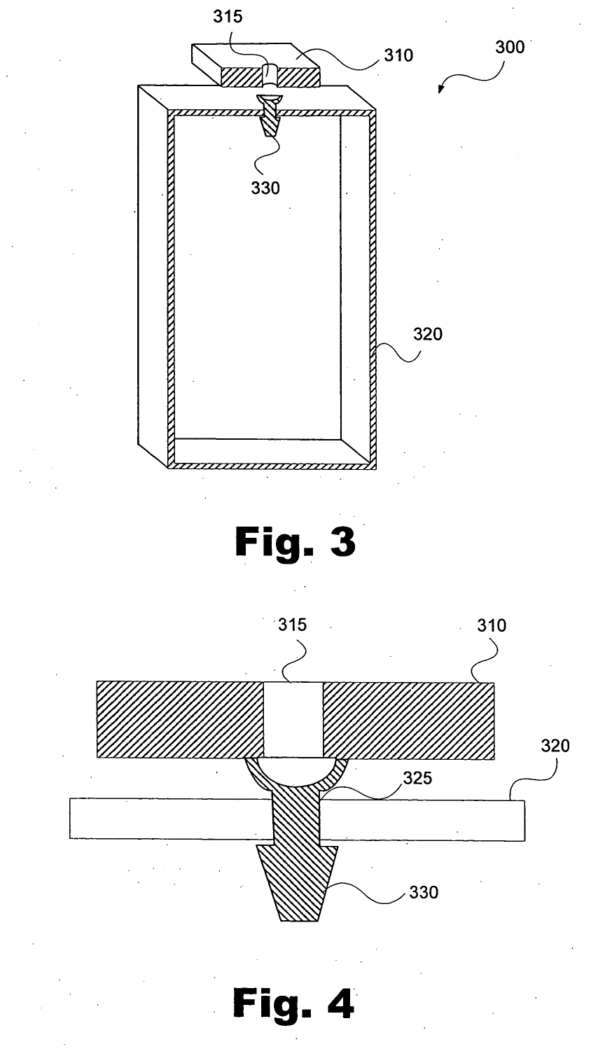

As the hydraulic fluid (220) expands due to an increase in temperature caused by operation of the hydraulic system (100; FIG. 1), the float (230) travels upward causing the sliding contact pin (240) to translate the ball valve (260) against the seal diameter (265) of the vent passage (275), thereby closing off the inner portion of the fill cup (205) to atmosphere. Also, on cool down of the hydraulic fluid (220), the vent valve (250) opens as the fluid cools and the float (230) drops, allowing ingested air to escape from the hydraulic fluid into the atmosphere. While the first exemplary embodiment is described above in the context of a vent valve (250) employing a ball valve (260), any number of valves may be used by the present system and method including, but in no way limited to, a needle valve, a poppet valve, an inverted umbrella valve, a ball valve, or any other type of valve device that closes off a vent to atmosphere when an overflow detection member such as a float indicates a rising level of the hydraulic fluid. The use and structure of additional valves will be further illustrated below with reference to FIGS. 3 through 10.

In the first exemplary embodiment illustrated in FIG. 2, there is no access to the atmosphere when the ball valve (260) is abutting the seal diameter (265) of the vent passage (275). However, residual air or gasses may still be trapped above the level of the hydraulic fluid (220). As the hydraulic fluid continues to expand due to thermal effects, pressure within the sealed fill cup (205) will increase. The increase in pressure within the fill cup (205) will be transferred to the hydraulic system (100; FIG. 1), thereby causing the expandable hose of the variable volume primary reservoir (120; FIG. 1) to expand to accommodate the increased volume of fluid. Consequently, the exemplary secondary reservoir (200) configuration illustrated in FIG. 2 automatically induces a desired expansion of the variable volume primary reservoir (120; FIG. 1) in response to a thermal expansion of the hydraulic fluid.

Additionally, the exemplary secondary reservoir (200) configuration illustrated in FIG. 2 is constructed to selectively vent excess air or other gas present in the system while preventing negative pressures that could induce cavitation of the pump (170; FIG. 1). According to the exemplary embodiment illustrated in FIG. 2, once the temperature of the hydraulic fluid (220) drops, pressure within the hydraulic system (100; FIG. 1) is reduced and the variable volume primary reservoir (120; FIG. 1) collapses, causing the level of the hydraulic fluid in the second reservoir to drop as well. Traditionally, this drop in the level of hydraulic fluid (220; FIG. 2) could cause negative pressures within the hydraulic system (100; FIG. 1). However, when such a drop in the level of hydraulic fluid (220) occurs in a system implementing the first exemplary secondary reservoir (200) illustrated in FIG. 2, the buoyant float (230) drops with the level of the hydraulic fluid. Consequently, the dropping float (230) induces a recess of the sliding contact pin (240) and the ball valve (260); opening the vent valve (250) to atmosphere. As the pressure is reduced in the fill cup (205) due to a reduction in volume occupied by the hydraulic fluid (220), additional air and other gasses may escape from solution and collect within the fill cup (205). This responsive opening of the fill cup (205) to atmospheric pressure corresponding to a descent of the level of hydraulic fluid (220) in the fill cup (205) allows excess air or other gasses that have become entrapped or ingested into the hydraulic fluid to escape to atmosphere through the vent tube (270).

As mentioned previously, any number of valve assemblies may be incorporated by the present system and method. As shown in FIG. 3, an inverted umbrella-type float and valve assembly (300) may be used as the vent valve in the present system and method. As illustrated in FIG. 3, the buoyant hollow float (320) includes an inverted umbrella seal (330) coupled thereto. The inverted umbrella seal (330) is disposed adjacent to the vent passage (315) of a seal plate (310). As shown in FIG. 4, when the float (320) approaches the seal plate (310) due to a rising level of hydraulic fluid (220; FIG. 2), the inverted umbrella seal (330) disposed in the float orifice (325) is forced against the vent passage of the seal plate (310), sealing the vent passage from the internal portion of the fill cup (205; FIG. 2). Also shown in FIG. 4, the rim portion of the concave face of the inverted umbrella seal (330) seals against the substantially planar face of the seal plate (310) to hermetically seal the fill cup (205; FIG. 2) from the vent passage (315).

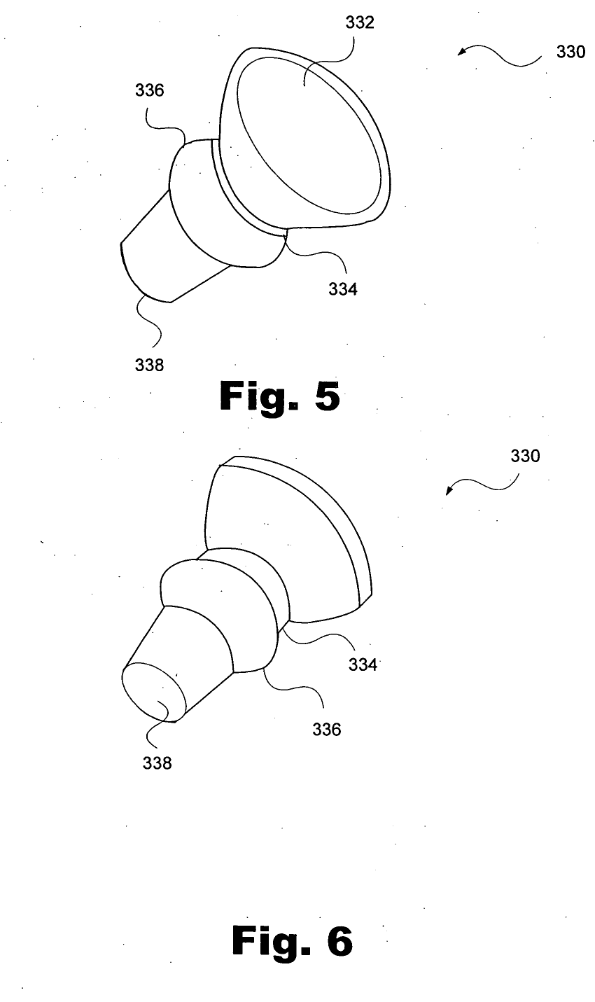

FIGS. 5 and 6 further illustrate the construction of the inverted umbrella seal (330), according to one exemplary embodiment. As illustrated in FIGS. 5 and 6, the inverted umbrella seal (330) includes a concave orifice face (332), the rim of which is configured to readily form a seal against a planar seal plate (310; FIG. 3). The concave orifice is recessed to a neck (334) that corresponds to the wall thickness of the float (320; FIG. 3). When inserted into a float (320; FIG. 3), the neck (334) portion of the inverted umbrella seal (330) interfaces with the float (320). The inverted umbrella seal (330) further includes a retention bulge (336) and an insertion point (338) formed adjacent to the neck (334) as illustrated in FIG. 6. During insertion into a float orifice (325; FIG. 4), the insertion point (338) is readily received by the float orifice, followed by the retention bulge (336). After the retention bulge (336) is fully passed through the float orifice (325; FIG. 4), the retention bulge forms an interference fit with the float orifice to securely retain the inverted umbrella seal (330) within the float orifice during operation.

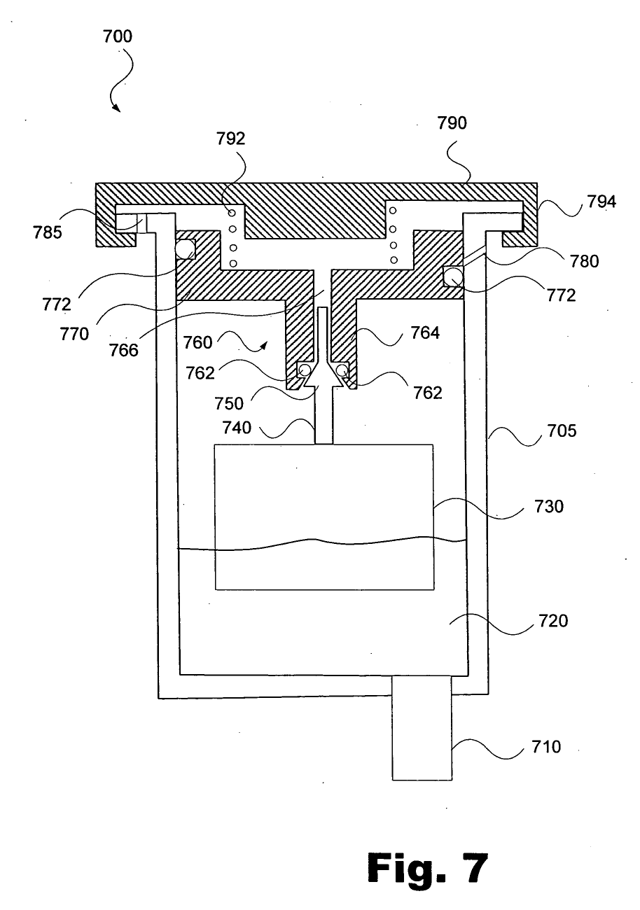

FIG. 7 illustrates a secondary reservoir configuration (700) according to a second exemplary embodiment configured to further improve the operation of a hydraulic system (100; FIG. 1) having a variable volume primary reservoir (120; FIG. 1). As illustrated in FIG. 7, the second exemplary embodiment includes a number of components similar to the components illustrated in FIG. 2. As shown, the secondary reservoir configuration (700) includes a fill cup (705) containing hydraulic fluid (720) fluidly coupled to a variable volume primary reservoir (120; FIG. 1) through a fluid coupler (710). Additionally, a float (730) having a float pin (740) and a poppet valve (750) coupled thereto is disposed within the hydraulic fluid (720) to selectively vary the access of the fill cup (705) to atmosphere.

However, in contrast to the first exemplary embodiment shown in FIG. 2, the second exemplary embodiment illustrated in FIG. 7 shows a vent valve (760) disposed on a valve carrier (770) associated with the cover (790). As illustrated in FIG. 7, the valve carrier (770) includes a vent valve (760) having a vent tube (764) including a vent passage (766) formed therein. Additionally, one or more vent o-rings (762) are coupled to a poppet valve receiving portion of the vent tube (764) to aid in fluidly sealing the vent passage (766) when blocked by the poppet valve (760). Moreover, one or more o-ring seals (772) are coupled to the valve carrier (770) to allow the valve carrier to sealingly translate within the fill cup (705). As illustrated in FIG. 7, the one or more o-ring seals (772) may be disposed in an angular recess formed in the valve carrier (770). By disposing the one or more o-ring seals (772) in an angular recess relative to a vertical axis of the fill cup (705), the o-ring will contact opposing walls of the fill cup (705) at staggered points as illustrated in FIG. 7. The staggered orientation of the o-ring contact will allow for a release of residual pressure as described in further detail below.

Similar to the first exemplary embodiment illustrated in FIG. 2, the secondary exemplary configuration provides access to atmosphere when the hydraulic fluid (720) level is low through the vent passage (766) and a cover vent (785) formed in the fill cup (705) as shown in FIG. 7. As the operating temperature increases, the hydraulic fluid (720) level rises in the fill cup (705) resulting in the poppet valve (750) to contact and seal against the vent o-ring (762), causing the pressure within the fill cup to increase. This increase in pressure is transferred into the variable volume primary reservoir (120; FIG. 1) through the fluid coupler (710). In response to the increased pressure, the variable volume primary reservoir (120; FIG. 1) expands in volume thereby accommodating the increase in volume of hydraulic fluid (720). As the hydraulic fluid (720) cools in temperature, the volume of the hydraulic fluid again decreases and the variable volume primary reservoir (120; FIG. 1) collapses causing the level of the float (730) within the secondary reservoir (700) to drop. This allows the poppet valve (750) to open and the fill cup (705) to again be vented to atmosphere through the vent passage (766) and the cover vent (785).

The second exemplary embodiment illustrated in FIG. 7 also shows the valve carrier (770) being coupled to a cover (790) by a cover spring (792) or other compressible member. The cover (790) is in turn coupled to the fill cup (705) by a number of cover tabs (794). The coupling of the valve carrier (770) to the cover (790) by a cover spring (792) or other similarly compressible member adds an increased level of safety when operating a hydraulic system (100; FIG. 1) incorporating the present secondary reservoir configuration (700). More particularly, the coupling of the valve carrier (770) to the cover (790) by a cover spring (792) or other similarly compressible member provides for a pressure release in the event of an overpressure condition.

As illustrated in FIG. 7, the valve carrier (770) is coupled to the cover (790) by a cover spring (792). The resistance provided by the cover spring (792) prevents the valve carrier (770) from being translated and exposing the vent port (780) to the interior of the fill cup (705) during normal operating pressures. However, if the hydraulic system (100; FIG. 1) experiences an over pressure condition, the spring force exerted by the cover spring (792) may be overcome, compressing the cover spring, and allowing a translation of the valve carrier (760) towards the cover (790). Once the valve carrier (760) is sufficiently translated, the o-ring seal will uncover the vent port (780), thereby relieving the overpressure condition without causing damage to the components of the hydraulic system (100; FIG. 1).

Another feature of the second exemplary embodiment is the configuration of the o-ring seal (772) relative to a vent port (780) formed in the fill cup (705) of the secondary reservoir (700). As noted previously, the o-ring seal (772) may be angled relative to the vertical axis of the secondary reservoir (700) rather than positioning the o-ring seal perpendicular to the axis. According to the secondary exemplary embodiment, when the cover (790) is removed from the fill cup (705), the o-ring seal (772) will uncover a vent port (780) disposed in the wall of the fill cup prior to complete removal of the cover. This will release any residual pressure present in the fill cup (705) prior to removal of the cover (790), thereby preventing possible injury to a user due to an escape of residual pressure.

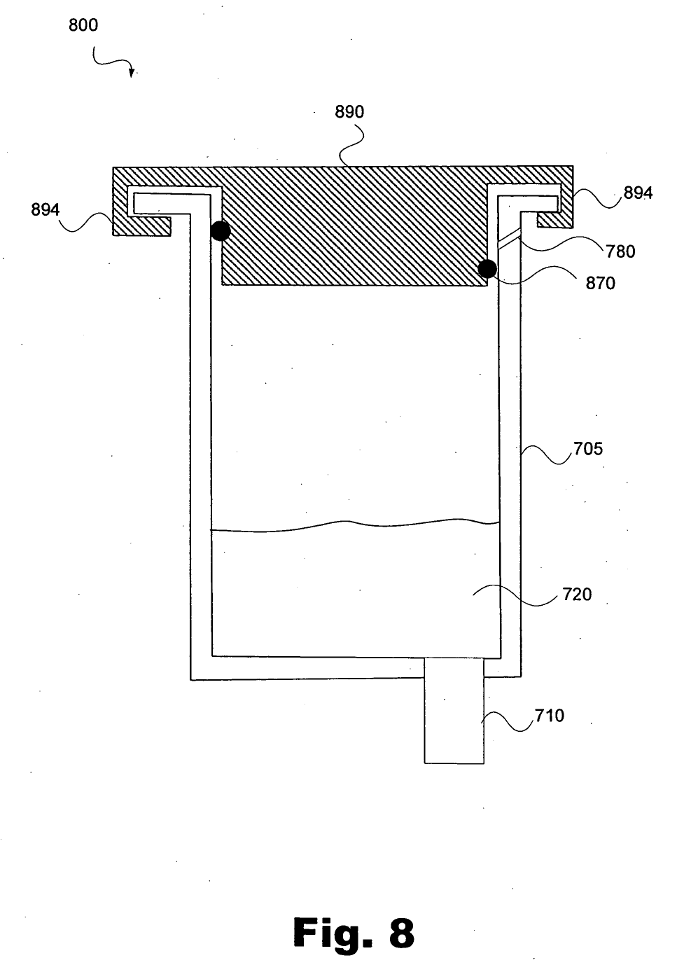

FIG. 8 illustrates an additional cover (890) construction that may be used with any number of valve configurations mentioned above in connection with a secondary reservoir (800) that uncovers a vent port (780) during removal of the cover (890). As illustrated in FIG. 8, the vent valve configurations have been omitted only to further focus on the components of the cover (890). As shown, the exemplary cover (890) illustrated in FIG. 8 includes an angled o-ring seal (870) sealing the cover to the fill cup (705). Additionally, the cover (890) is coupled to the fill cup (705) by a number of cover tabs (894). Close inspection of the cover tabs (894) will reveal that the cover tabs have varied lengths. By varying the lengths of the cover tabs (894), assembly of the solid cover (890) and consequently the angled o-ring seal (870) is limited to the orientation shown with the angled o-ring seal separating the interior of the fill cup (705) from the vent port (780) when installed. However, when the cover (890) is twisted to be removed from the fill cup (705), the angled o-ring seal (870) will expose the vent port (780) to the interior of the fill cup prior to complete removal of the cover. This exposure of the vent port (780) will release any residual pressure present in the fill cup (705) prior to removal of the cover (790), thereby preventing a possible pressure related injury to a user.

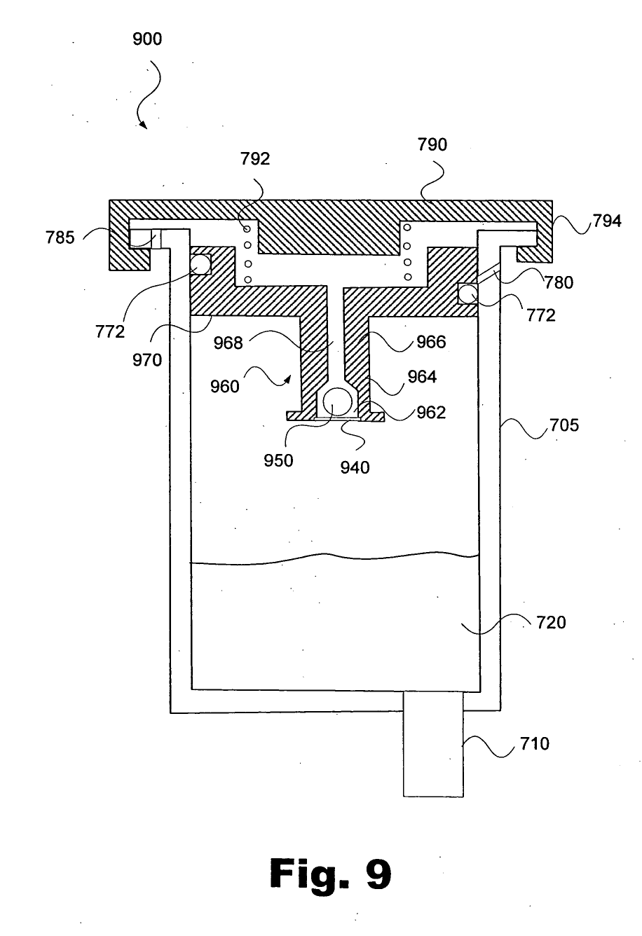

Turning now to FIG. 9, yet another possible vent valve configuration is illustrated according to a third exemplary embodiment. As shown in FIG. 9, the float (730; FIG. 7) may be eliminated by incorporating a valve carrier (970) having a buoyant sphere (950) or other buoyant three-dimensional object disposed within a chamber (962) of the vent valve (960). As illustrated in FIG. 9, the valve carrier (970) may include an o-ring seal (772) and a vent tube (966) having a vent passage (968) as illustrated in the previous exemplary embodiments. However, as illustrated in FIG. 9, the vent valve (960) may include a chamber (962) defined by the vent tube (966) walls and a tapered neck (964) leading to the vent passage (968), the chamber (962) having a buoyant sphere (950) disposed therein. Additionally, a hydraulic fluid permeable screen (940) completes the chamber (962) on the side adjacent to the fluid coupler (710) of the fill cup (705).

During operation of the hydraulic system (100; FIG. 1), the secondary reservoir (900) will be vented to atmosphere through the cover vent (785) and the vent passage (968) when the hydraulic fluid (720) is cool. As the hydraulic fluid (720) within the fill cup (705) begins to heat up, the level of hydraulic fluid contained within the fill cup (705) will rise. As the level of the hydraulic fluid (720) reaches the bottom of the chamber (962) it will pass through the fluid permeable screen (940) and fill the chamber as well as the fill cup (705). As the chamber fills with hydraulic fluid (720), the buoyant sphere (950) will be forced into the neck (964) of the chamber and will seal the vent passage (968) from the hydraulic fluid. This sealing of the vent passage (968) will increase the pressure within the fill cup (705) and the hydraulic system (100; FIG. 1), thereby initiating the expansion of the variable volume primary reservoir (120; FIG. 1), as described above. Additionally, as described above, the cooling and consequential recess of the hydraulic fluid (720) from the fill cup (705) will allow the buoyant sphere (950) to descend from the chamber neck (964) again establishing the venting of the fill cup. By utilizing a buoyant sphere (950) in the vent valve (960) rather than a large float (730; FIG. 7), useable volume within the fill cup (705) may be increased and/or the effective size of the secondary reservoir may be decreased.

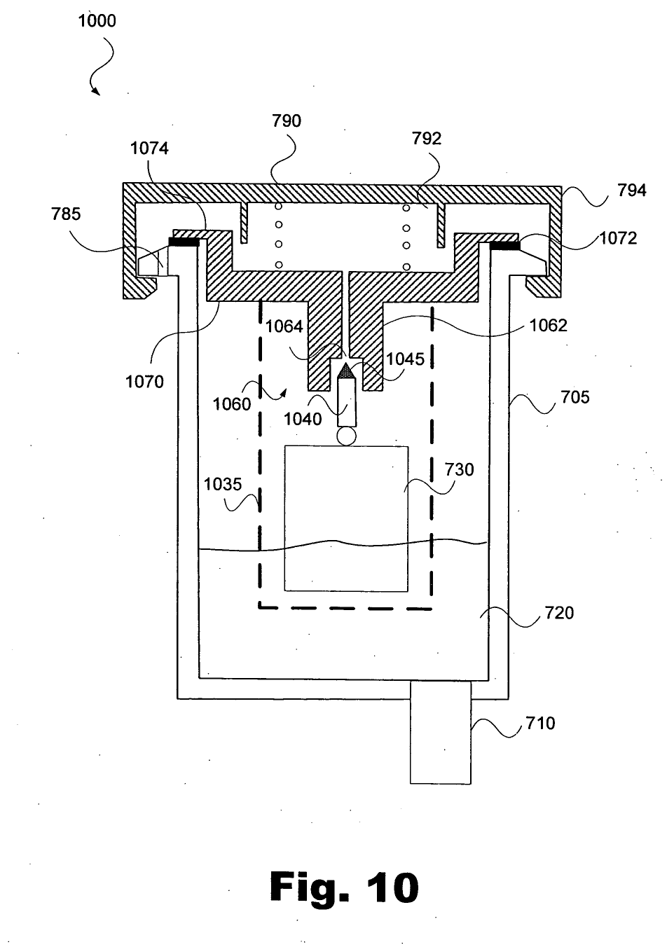

FIG. 10 illustrates yet another secondary reservoir (1000) configuration that may be incorporated into a hydraulic system (100; FIG. 1) including a variable volume primary reservoir (120; FIG. 1), according to a fourth exemplary embodiment. As illustrated in FIG. 10, the secondary reservoir may include a vent valve (1060) having a needle valve (1040) associated with a float (730). The needle valve (1040) illustrated in FIG. 10 includes a compressible needle tip (1045) configured to sealingly engage a passage opening (1064) of a vent passage (1066) formed in the vent tube (1062). As mentioned above, as the amount of hydraulic fluid (720) contained within the fill cup (705) increases, the buoyant float rises with the fluid and forces the compressible needle tip into the passage opening (1064), thereby sealing the fill cup (705) from the atmosphere.

FIG. 10 also illustrates a float containment member (1035) coupled to the valve carrier (1070). According to this fourth exemplary embodiment, the float containment member is associated with the float (730) and assures that the float may be removed with the valve carrier (1070). The float containment member may be in any number of restraint configurations including, but in no way limited to, a cage or a chain.

FIG. 10 also illustrates an alternative method for providing overpressure protection in the secondary reservoir (1000). As shown in FIG. 10, the valve carrier (1070) includes a sealing flange (1074) extending from the top portion thereof. The sealing flange (1074) is configured to rest upon the upper rim of the fill cup (705) as shown in FIG. 10. A gasket seal (1072) is placed between the sealing flange (1074) and the upper rim of the fill cup (705). Accordingly, the cover spring (792) will exert a downward force on the valve carrier (1070), compressing the gasket seal (1072) with the sealing flange (1074). In this manner, the fourth exemplary embodiment illustrated in FIG. 10 will seal the fill cup (705) during normal operating pressures. If an over-pressure condition exists, the downward spring force may be overcome, exposing the fill cup (705) to the cover vent (785) to remedy the overpressure condition.

In conclusion, the present systems and methods for providing a vent valve for a re-circulating hydraulic system provide for controlling the expansion of a variable volume primary reservoir based on the thermally activated expansion of the hydraulic fluid in the system. More specifically, by regulating venting access to the fill cup based on a floating valve interface, the present system and method is both cost effective and reliable. Additionally, the present exemplary systems and methods readily provide for pressure equalization during cool down of the hydraulic fluid, venting of excess air and gas, and provide for overpressure regulation.

The preceding description has been presented only to illustrate and describe exemplary embodiments of the present systems and methods. It is not intended to be exhaustive or to limit the systems and methods to any precise form disclosed. Many modifications and variations are possible in light of the above teaching. It is intended that the scope of the systems and methods be defined by the following claims.

1. A secondary reservoir for a power steering system comprising:
a container including an inside volume configured to hold a fluid;
a cover coupled to said container;
a float disposed with in said container, wherein said float is configured to assume a height within said container indicative of a level of the fluid within said container; and
a vent valve associated with said float, said vent valve being configured to couple said inside volume of said container to an outside atmosphere when said float is at a relatively low level within said container and to close said inside volume of said container to an outside atmosphere when said float is above said low level.

2. The secondary reservoir of claim 1, wherein said vent valve comprises a needle valve.

3. The secondary reservoir of claim 1, wherein said vent valve comprises a ball check valve.

4. The secondary reservoir of claim 1, wherein said vent valve comprises an inverted umbrella valve.

5. The secondary reservoir of claim 1, wherein said vent valve comprises a poppet valve.

6. The secondary reservoir of claim 1, further comprising a slideable valve carrier configured to house said vent valve, said slideable valve carrier being sealingly disposed within said container;
said slideable valve carrier including a sealing member configured to selectively seal said container.

7. The secondary reservoir of claim 6, wherein said sealing member comprises an o-ring;
said o-ring being positioned on said slideable valve carrier at non-tangential angle relative to a vertical axis of said container.

8. The secondary reservoir of claim 7, further comprising a vent port formed in said container, wherein said cover o-ring transverses said vent port when said cover is removed from said container.

9. A secondary reservoir for a hydraulic system comprising:
a fill cup including an inside volume configured to contain a hydraulic fluid;
a fluid orifice disposed in said fill cup, said fluid orifice being configured to fluidly couple said inside volume to the hydraulic system;
a vent passage disposed in said fill cup, said vent passage fluidly coupling said inside volume to an external atmosphere; and
a vent valve disposed in said vent passage, wherein said vent valve is configured to selectively form a hermetic seal in said inside volume in response to a level of said hydraulic fluid.

10. The secondary reservoir of claim 9, further comprising:
a buoyant member associated with said vent valve;
said buoyant member being configured to initiate an obstruction of said vent passage in response to a level of said hydraulic fluid in said inside volume.

11. The secondary reservoir of claim 10, wherein said vent valve further comprises one of a ball valve, a poppet valve, a needle valve, or an inverted umbrella seal, associated with said buoyant member.

12. The secondary reservoir of claim 9, wherein said fill cup further comprises:
a vent orifice formed in said fill cup; and
a slideable valve carrier sealingly disposed within said fill cup, said slideable valve carrier including a sealing member selectively sealing said inside volume from said vent orifice.

13. The secondary reservoir of claim 12, further comprising a compressible member coupling said slideable valve carrier to said fill cup;
said compressible member being configured to selectively translate said slideable valve carrier to couple said inside volume to said orifice.

14. The secondary reservoir of claim 13, wherein said compressible member is configured to couple said inside volume to said vent orifice in response to a pressure level in said inside volume.

15. The secondary reservoir of claim 13, wherein said compressible member comprises a spring.

16. The secondary reservoir of claim 12, wherein said sealing member comprises one of an o-ring or a gasket seal.

17. The secondary reservoir of claim 16, wherein said sealing member is positioned on said slideable valve carrier at an angle relative to a vertical axis of said container.

18. The secondary reservoir of claim 17, wherein said sealing member is configured to transverse said vent orifice when said valve carrier is removed from said fill cup.

19. The secondary reservoir of claim 12, further comprising a float containment member coupled to said slideable valve carrier.

20. A secondary reservoir for a hydraulic system comprising:
a fill cup including an inside volume configured to contain a hydraulic fluid, a vent orifice formed in said fill cup, and a slideable valve carrier sealingly disposed within said fill cup, said slideable valve carrier including a sealing member selectively sealing said inside volume from said vent orifice;
a cover coupled to said fill cup;
a spring member coupling said slideable valve carrier to said cover, said spring member being configured to selectively translate said slideable valve carrier in response to a pressure inside said inside volume;
a fluid orifice disposed in said fill cup, said fluid orifice being configured to fluidly couple said inside volume to said hydraulic system;
a vent passage disposed in said fill cup, said vent passage fluidly coupling said inside volume to an external atmosphere;
a vent valve disposed in said vent passage, wherein said vent valve is configured to selectively form a hermetic seal in said inside volume in response to a level of said hydraulic fluid in said inside volume; and
a buoyant member associated with said vent valve, wherein said buoyant member selectively translates said vent valve to obstruct said vent passage in response to a level of said hydraulic fluid in said inside volume.

21. The secondary reservoir of claim 20, wherein said vent valve further comprises one of a ball valve, a poppet valve, a needle valve, or an inverted umbrella seal associated with said buoyant member.

22. The secondary reservoir of claim 20, wherein said spring member is configured to couple said inside volume to said orifice in response to a pressure level in said inside volume.

23. The secondary reservoir of claim 20, wherein said sealing member comprises one of an o-ring or a gasket seal.

24. The secondary reservoir of claim 20, wherein said sealing member is positioned on said slideable valve carrier at an angle relative to a vertical axis of said container;
said sealing member being configured to traverse said vent orifice when said valve carrier is removed from said fill cup.

25. The secondary reservoir of claim 20, further comprising a float containment member coupled to said slideable valve carrier.

26. A reservoir system for a hydraulic system comprising:
a first reservoir including a variable volume primary reservoir configured to increase in volume in response to an increase in pressure;
a second reservoir fluidly coupled to said first reservoir, wherein said second reservoir includes a fill cup having an inside volume configured to receive excess hydraulic fluid from said first reservoir, a vent passage disposed in said fill cup, said vent passage fluidly coupling said inside volume to an external atmosphere, and a vent valve disposed in said vent passage, wherein said vent valve is configured to selectively form a hermetic seal in said inside volume in response to a level of said hydraulic fluid.

27. The reservoir system of claim 26, wherein said vent valve is configured to form said hermetic seal in response to a rise of said hydraulic fluid.

28. The reservoir system of claim 27, wherein said hermetic seal is configured to initiate an increase in volume of said first reservoir.

29. The reservoir system of claim 26, wherein said second reservoir further comprises:
a vent orifice formed in said fill cup;
a slideable valve carrier sealingly disposed within said fill cup, said slideable valve carrier including a sealing member selectively sealing said inside volume from said vent orifice; and
a compressible member coupling said slideable valve carrier to said fill cup;
said compressible member being configured to selectively couple said inside volume to said orifice in response to an overpressure condition.

30. The reservoir system of claim 29, wherein said sealing member is positioned on said slideable valve carrier at an angle relative to a vertical axis of said container;
wherein said sealing member is configured to release residual pressure from said second reservoir when said valve carrier is removed from said fill cup.

31. A method for accommodating thermal fluid expansion in a hydraulic system comprising:
selectively sealing a secondary reservoir containing hydraulic fluid in response to a level of said hydraulic fluid within said secondary reservoir.

32. The method of claim 31, further comprising:
disposing a float within said secondary reservoir, said float being configured to assume a height indicative of a level of the fluid within said secondary reservoir; and
associating a vent valve with said float, wherein said vent valve is configured to open said secondary reservoir to an outside atmosphere when said float is at a relatively low level within said secondary reservoir and to close said secondary reservoir to the outside atmosphere in response to a rise of said float.

33. The method of claim 32, wherein said vent valve comprises one of a ball valve, a poppet valve, a needle valve, or an inverted umbrella seal, slideably coupled to said float.

34. The method of claim 31, further comprising:
slideably coupling a vent valve carrier within said secondary reservoir, said vent valve being disposed on said vent valve carrier;
forming a vent port in said secondary reservoir; and
coupling said vent valve carrier to said secondary reservoir with a spring member;
wherein said vent valve carrier is configured to expose said vent port in response to an overpressure condition.
